(19) United States
(12) Patent Application Publication
(10) Pub. No.: US 2022/0351582 A1
(43) Pub. Date: Nov. 3, 2022

(54) EPHEMERAL BETTING IN IMMERSIVE ENVIRONMENTS

(71) Applicant: C360 Technologies, Inc., Wexford, PA (US)

(72) Inventors: Brian C. Lowry, Emlenton, PA (US); Joseph B. Tomko, Wexford, PA (US); Evan A. Wimer, Pittsburgh, PA (US)

(21) Appl. No.: 17/774,417

(22) PCT Filed: Nov. 4, 2020
(86) PCT No.: PCT/US2020/058911

§ 371 Date: May 4, 2022

Related U.S. Application Data
(60) Provisional application No. 62/930,958, filed on Nov. 5, 2019.

(51) Int. Cl. G07F 17/32; G06Q 50/34

(52) U.S. Cl. CPC G07F 17/3288; G07F 17/323; G07F 17/3272; G07F 17/3211; G07F 17/3209; G07F 17/3267; G06Q 50/34

(57) ABSTRACT

Described is a system and method for ephemeral betting within a panoramic video environment. A panoramic video environment is defined as a virtual experience, viewed on an information handling device (e.g., personal computers, mobile devices, virtual reality headsets, smart televisions, etc.) where the user views a panorama from a first person perspective relative to the camera capturing the video. The “view” may be a two-dimensional “portal” into the panoramic environment, or a stereoscopic view. The user will typically have directional control in the view portal, including the ability to pan, tilt, and zoom from the perspective of the camera. The described system and method creates wagering opportunities by combining the experience of viewing an event, simultaneously with other spectators, with real-time analytics and statistics derived from an object tracking system, thereby providing ephemeral wagering opportunities.

### CROSS REFERENCE TO RELATED APPLICATION

This application is a PCT of U.S. Provisional Application Ser. No. 62/930,958, entitled “EPHEMERAL BETTING IN IMMERSIVE ENVIRONMENTS”, filed on Nov. 5, 2019, which is incorporated by reference in its entirety.

### BACKGROUND

Virtual Reality (VR), augmented reality (AR), and immersive video and gaming are becoming increasingly popular ways to experience sports and entertainment. The attributes of a quality experience are that it is accessible (i.e., content must be available on any device and at any time), social (i.e., users must be able to interact with their peers), and interactive (i.e., the user must feel like he/she is in control). Examples of such experiences include Intel's VR coverage of the 2018 Winter Olympics, as well as Niantic Lab's popular AR game, POKEMON GO®, which captured over 150 million active users in 2018. As a means for experiencing live sports, the system disclosed herein encompasses these qualities, while adding the revenue-generating aspect of betting. POKEMON GO is a registered trademark of Nintendo of America in the United States and other countries.

### BRIEF SUMMARY

In summary, one aspect of the invention provides a method, comprising: transmitting, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes; receiving tracking information corresponding to positions of objects within the live event; providing, on a user interface of each of the plurality of users, betting information within the panoramic augmented video stream; receiving, from at least one of the plurality of users, input corresponding to a bet by the at least one of the plurality of users in response to the betting information; and registering the bet within a betting client.

Another aspect of the invention provides a system, comprising: a processor; a memory device comprising instructions executable by the processor to: transmit, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes; receive tracking information corresponding to positions of objects within the live event; provide, on a user interface of each of the plurality of users, betting information within the panoramic augmented video stream; receive, from at least one of the plurality of users, input corresponding to a bet by the at least one of the plurality of users in response to the betting information; and register the bet within a betting client.

An additional aspect of the invention provides a product, including: a storage device that stores code, the code being executable by a processor and comprising: code that transmits, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes; code that receives tracking information corresponding to positions of objects within the live event; code that provides, on a user interface of each of the plurality of users, betting information within the panoramic augmented video stream; code that receives, from at least one of the plurality of users, input corresponding to a bet by the at least one of the plurality of users in response to the betting information; and code that registers the bet within a betting client.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the system will be pointed out in the appended claims.

### BRIEF DESCRIPTION OF THE SEVERAL VIEWS OF THE DRAWINGS

FIG. 1 illustrates example types of panoramas.

FIG. 2 illustrates an example information handling device.

FIG. 3 illustrates an example panorama system within an event environment.

FIG. 4 illustrates an example mapping of sensor information received from two cameras into a single sphere.

FIG. 5 illustrates an example of object tracking.

FIG. 6 illustrates an example method of ephemeral betting during an immersive event.

FIG. 7 illustrates an example panoramic view of an immersive event.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In 2017, the state of New Jersey challenged the federal Professional and Amateur Sports Protection Act (PASPA). This 1992 law granted immunity to four states that had previously allowed sports betting inside their borders. On May 14, 2018, the US Supreme Court issued a decision to reverse the ban, striking down PASPA in full. Since that decision, other states have legally offered sports betting. The global sports betting market, anticipated to be valued at more than 94 billion U.S. dollars in 2024, continues to grow, fueled by catalysts such as increasing trust on digital payment methods for betting, more disposable income, and wide-scale adoption of web-based devices such as smart phones and smart TVs.

One of the fastest-growing sports markets in terms of betting volume is eSports, which is described as the world of competitive, organized video gaming. Viewers watch, in real-time, for example, via streaming services, as competitors face-off in online video games. Tournaments can easily attract crowd sizes rivaling traditional professional sports matches. According to some sources, revenues from eSports wagering rose from $5.5B in 2016 to early $13B at the end of 2018, with 557 million viewers projected by 2021. This growing volume is driving revenue generation across the sports betting industry. Sportsbooks have responded to their consumers' demand for increased connectivity, and bettors are seizing new opportunities made available by these advances.

Traditional wagering systems enable bettors to bet on the outcome of a game. In other words, “which team will win?”, and “by how much?” Sport book makers determine accurate probabilities for each outcome (e.g., win, loss, and point spread) so that they can offer competitive odds to potential bettors. These odds are typically computed prior to the start of the game, based upon historical, statistical, and anecdotal data related to each team, player, coaching staff, venue, opinions, etc. For example, in American football, odds for a player's or team's total rushing yards or attempts, down conversions (first or third), interceptions, completions, field goal percentage, and the like, may be computed. As another example, in basketball, odds for a player's or team's total assists, blocks, turnovers, steals, and the like, may be computed. As a final example, in baseball, odds for a player's or team's total number of home runs, RBIs, and the like, may be computed.

Increasing in popularity is the concept of micro betting. Unlike traditional betting where the odds are cast prior to the event, micro bets can be placed, using soccer as an example, on the likelihood of the following taking place: throw-ins, free kicks, goal kicks, shots on goal, corner kicks, or the like. However, the types of micro bets are pre-defined, as are their time windows (typically 15 minutes). In other words, we know that during a soccer game there will be shots on goal, so it is trivial to establish a time window and wager against whether that will happen or not. The system and method as described herein differs in that it anticipates the types of bets that are imminent based upon the location of tracked objects in the immersive space, with the possibility of indeterminate timing.

One conventional system allows for providing wagering information in real time utilizing an Internet connection to display the odds from a plurality of sports books. However, the actual event upon which the user is wagering occurs outside the context of the interaction. Another system describes methods and systems for managing a wagering system, with odds being calculated from a plurality of inputs including historical and current state (in-game) information, thus creating a betting market. However it relies on either human operators or identification modules to analyze the video (post occurrence) via image analysis techniques to determine the event outcome. In many sports scenarios, this is tedious if possible at all, error-prone, and can possibly result in divergences from “real-time”. Additionally, the system is distinct from the viewing of the actual event, i.e., it is an ancillary computer or gaming view of the wagering process. For example, for football wagering, a mock football field with player/scores/ball state are shown; this is not the live, real-time video from the broadcast. In other words, the bettors must interact with the betting system as well as with the broadcast of the event.

What is needed in the industry is a technological convergence of live sports, immersive control of the sports experience, social context, gaming, and betting that is not constrained by the limitations of antiquated technology. We refer to this as the “gamification” of sports and entertainment. What this system enables is wagering scenarios that are ephemeral; in other words, transient events that occur during an event. For example, in a natural exchange during a basketball game, one might wager with a friend “I'll bet you that a basketball player makes a three point shot in the next two minutes.” This type of bet is temporal, and cannot be captured in any way prior to the event, yet it represents a commonplace wagering scenario. Another scenario may be in the context of a reality show such as AMERICAN NINJA WARRIOR®, where contestants compete to have the lowest time in completing an obstacle course. A spectator may say “I will wager that contestant Jane completes five of the ten challenges.” AMERICAN NINJA WARRIOR is a registered trademark of Tokyo Broadcasting System Television, Inc. in the United States and other countries.

Unlike the eSports betting—which is based entirely on a virtual gaming world, this system involves capturing the physical world or milieu via a single or plurality of panoramic cameras. The described system and method augments the real world with graphics, with the differentiator being that all participants in an event are viewing the same event, not their immediate physical surroundings, albeit with the ability to control their individual pan, tilt, and zoom in the shared environment. Enabling the graphical augmentation as well as providing data for the betting engine is the ingestion of real-time tracking data.

Object tracking is becoming increasingly commonplace, and is well known in the marketplace. Many of the professional sports teams and leagues have alliances with tracking providers. The analytics gleaned from tracking are used for player performance statistics (time with ball, speed), play analytics (defensive and offensive strategies), coaching, etc. Object tracking technology differs greatly from sport to sport. Optical tracking is non-invasive, relying on multiple cameras and Artificial Intelligence (AI) algorithms. This type of tracking works well for “small field” sports such as hockey and basketball. Other means include RF tracking which employs transmitters located on the player (and ball), and receivers located off field. This method is ideal for large field sports, such as soccer. Spatial resolution is typically <1 m, with temporal resolutions less than 10 milliseconds (ms). For low-speed tracking, global positioning system (GPS) tracking may suffice.

The described system and method purports to enable wagering scenarios based upon objects (e.g. players, the ball, contestants, etc.) within the video captured by the one or plurality of panoramic video cameras. This is accomplished by synchronizing tracking information with each video frame as taught in the authors' previous patents. Since the geometry of the captured video space is known a priori, or can be mapped by using fiducials, relative velocities and accelerations can be calculated, and, combined with player statistics, used to create betting scenarios. These, combined with real-time augmented graphics, allow for the “gamification” of live sports, entertainment, and “reality” shows, which will resonate with the demographics engaged in those pursuits.

The described system and method is agnostic to the tracking methodology employed. Additionally, the described system and method relies on a low-latency stream of object coordinates in a space calibrated with the camera system.

The description now turns to the figures. The illustrated embodiments of the system will be best understood by reference to the figures. The following description is intended only by way of example and simply illustrates certain example embodiments.

It should be noted that the flowchart and block diagrams in the figures illustrate the architecture, functionality, and operation of possible implementations of systems, apparatuses, methods and computer program products according to various embodiments of the system. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following patents, in their entirety, are incorporated herein by reference: U.S. patent application Ser. No. 10/094,903 now U.S. Pat. No. 9,588,215, titled “OBJECT TRACKING AND DATA AGGREGATION IN PANORAMIC VIDEO” U.S. patent application Ser. No. 15/753,022, titled “GENERATING OBJECTS IN REAL TIME PANORAMIC VIDEO”, U.S. Provisional Application 62/310,244, titled “SHARED EXPERIENCES IN PANORAMIC VIDEO” and U.S. Provisional Application 62/571,876, titled “CREATING MULTI-CAMERA PANORAMIC PROJECTIONS”.

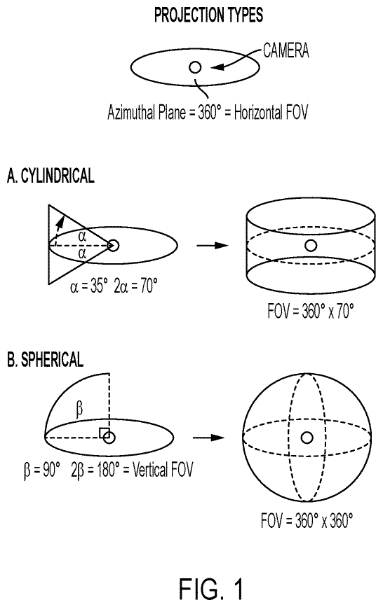

FIG. 1 illustrates various types of panoramas. For each of these panoramas, a camera capable of capturing video in the space described is required. For example, in order to capture video in a hemisphere, a camera must be employed that has a Field of View (FOV) of 360°×180°. The FOV is defined as the extent of the observable world, as “seen” or captured by the camera. The systems defines both a horizontal and vertical FOV, as Euclidean planar angles, rather than a solid angle. In FIG. 1A, a cylindrical projection is made by sweeping out a vertical field of view (VFOV), for example, 70° over a 360° azimuthal angle. Similarly, the generation of a complete spherical projection is shown in FIG. 1B. To capture a complete sphere, two hemispherical-capture cameras must be employed, or a multiplicity of smaller FOV cameras where a “stitching” process is used to combine the multiple videos into a single panorama, as is routine and well understood. The present embodiment employs either a single sensor, single optic camera to produce a hemispherical panorama, or two such cameras “back-to-back” with a single stitch along the equator, yielding a complete spherical panorama. The above mentioned U.S. Patent Applications and Patents teach how to composite multiple cameras into a single, streamed immersive sphere.

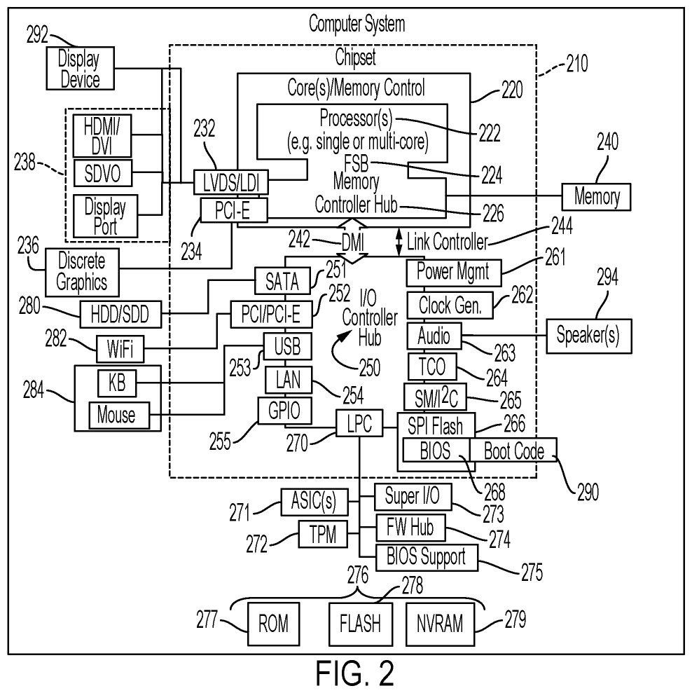

While various other circuits, circuitry or components may be utilized in information handling devices, with regard to information handling device circuitry, an example as illustrated in FIG. 2. In FIG. 2 the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

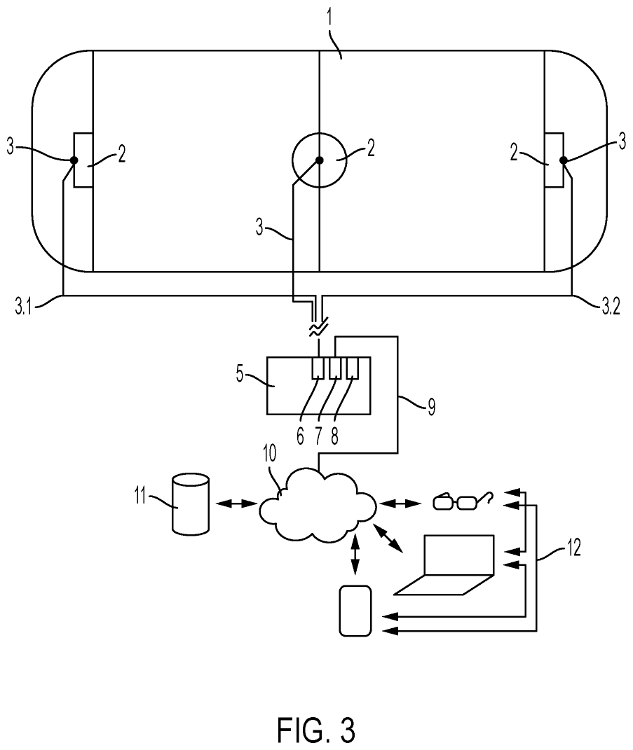

As an example, a typical immersive event and capturing of the information necessary for creation of the immersive experience is shown in FIG. 3. The example event shown in FIG. 3 is a hockey event. This is merely an example and is not intended to be limiting, as any live event can be utilized within the described system and method. Assume that a panoramic camera is located directly under the scoreboard, at center ice, as well as two additional cameras, one in each net, in a hockey arena (event facility). The camera system, in this embodiment, is capable of capturing a HFOV and VFOV of 180°—a hemispherical panorama such that the entire arena space located at or below the level of the camera can be “seen”. The in-net cameras capture a “first-person” field of view as seen by each goalie. As noted, in the present embodiment, the cameras are semi-permanently located at the event facility. Cameras may, however, be attached to trolleys on movable cable systems, as is common in field sports, such as soccer and American football.

The camera communicates with a remote workstation (5), typically located in a production truck that can be 1-10 km from the location of the cameras. The communication is accomplished by utilizing one or more fiber optic links (3.1, 3.2, 3.3), as is common in the industry. The fiber links (3.1, 3.2, 3.3) connect to a frame grabber card (6) situated in the remote workstation (5). Alternatively, the communications may be accomplished via wireless technology, either via the cellular data network (4G or 5G), or using radio frequencies (e.g., WIFI). The frame grabber (6) driver, along with custom software, allows for the direct transfer of video frames from the frame grabber memory to the graphics processing unit (GPU—8). The GPU (8) is specifically designed to process video frames at high rates, whereas the workstation central processing unit (CPU) is designed for more general purpose tasks. Thus, the objective is to transfer video frames from the frame grabber (6) to the GPU (8) with as little CPU intervention as possible, as this would degrade performance. The present embodiment describes having multiple cameras connected to the workstation. This is a non-limiting embodiment, since the workstation may contain multiple frame grabbers, each connected to multiple cameras, or could have as few as a single camera. The practical limitations to the number of cameras are dictated by the state of the art of both computers and their buses. In the case of modern computers, the standard bus interface is PCI (Peripheral Connect Interconnect), and its derivatives—PCIe (PCI-Express). The PCI bus standard continues to evolve, with each iteration increasing the number of “lanes” resulting in a greater number of Gigabytes per second, thus facilitating the transfer of video frames at a greater rate or of a greater resolution, or both.

In another embodiment, one or more of the “live” cameras may be replaced or augmented by additional video content. For example, in a live sports production, the signal that is telecasted and viewed by users via television or cable may be ingested by the workstation (5) in a similar manner in which the camera feeds are ingested. In this case, each telecast video frame may be synchronized with the camera frames, and the software can be instructed to embed such content in the projection in any number of ways, such as a Picture-In-Picture, or the like.

Once video frames are pushed to the GPU (8) memory, they are pushed sequentially through the video pipeline. Typical operations are debayering (demosaicing), denoising, white balance adjustment, the application of 3D LUTs (Look-Up Tables) used for color correction, and the like. These video pipeline operations are required to improve the video quality for adherence to professional video standards. These video pipeline operations are performed in custom software optimized for GPU processing. Additionally, the system may employ software and libraries that are written in a processing language corresponding to the selected GPU. The processing language may allow for harnessing the massively parallel processing architecture of the corresponding GPU.

The next operations on the GPU (8) consist of transformational operations. These transformational operations are used to create the composited projection that is encoded and streamed. The captured video is transformed into an equirectangular, or a portion of an equirectangular, projection. Depending on the lens used, the images may be seen as different shapes. For example, utilizing a fisheye lens, the lens images the scene as a circle or truncated circle, in the case that the image is larger than a dimension of the CMOS sensor, on the camera sensor (CMOS), which is typically 4:3 or 16:9 in aspect ratio. The optics are designed to efficiently fill the CMOS area by adding optical distortion which will be removed by a mathematical transformation of the image during playback. As another example, an anamorphic lens may be used, imaging the scene as an oval on the sensor. The motivation for doing this is to spread the image out over as many sensor pixels as is possible, relaying on the mathematical dewarping of the image to produce rectilinear corrected video frames.

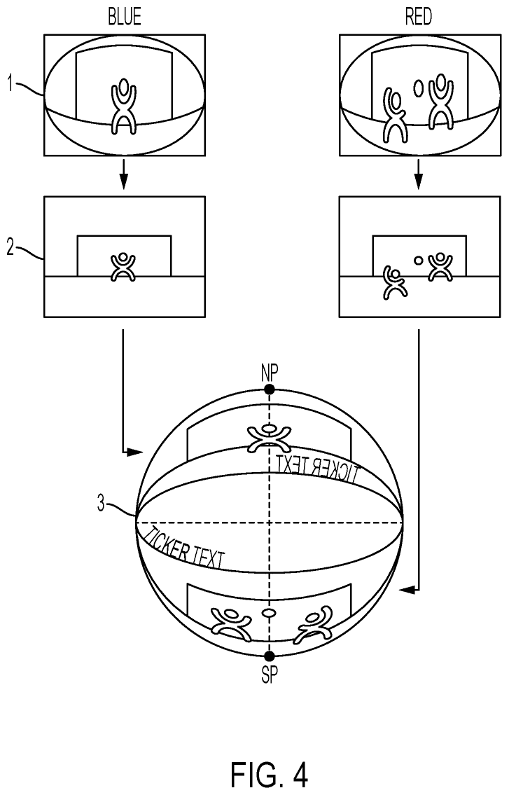

For a hemispherical camera, the circle will map (transform) into one half of an equirectangular projection. The mathematical transform maps pixels in the source video frame (circle) to the equirectangular video frame. There is nothing limiting in this disclosure concerning the specific composited projection type. Equirectangular is the de facto standard at the writing of this disclosure. Other projections, such as cube map and equiangular cube map are becoming increasingly popular. The same compositing feature that is described here is invariant with respect to the projection type, as the mapping is a trivial, low latency computation. For the purposes of readability, the disclosure will continue to use the equirectangular projection as the example. However, as stated above, this is not intended to be limiting. Two cameras, each capturing a 360°×180° FOV, can be composited to form a single equirectangular projection such that views are diametrically opposed as shown in FIG. 4.

FIG. 4 shows the sensor information captured by each of two cameras—one for the Blue Team and one for the Red Team. Element 2 shows a “flattened” or planar view within the oval, framing a particular object of interest—the net and goalie. Furthermore, FIG. 4 demonstrates how two entire sensor frames can be mapped to a single sphere, which in turn is transformed to an equirectangular projection for transport and consumption.

There are limitless ways for composting videos in the manner described above. As a non-limiting example, the system can capture video frames five video cameras and create a composited equirectangular projection as follows: one half of the equirectangular projection can consist of a panoramic video capture (hemisphere), while the opposite half can consist of four quadrant views. These compositing operations may be “hard coded”, or it may be operator-directed in real time. For example, a system may ingest four cameras, while the operator chooses two at any given time to be composited.

Graphics may be drawn on the composited video as shown in FIG. 4. Graphics may consist of static and dynamic images, or three dimensional models. In one embodiment, a meridional band is drawn, separating the two hemispherical camera views. This graphics band can display, for example, the Blue and Red team scores, the game clock, logos, and other relevant information, including betting information as will be discussed below.

Upon building the composited projection, each video frame is encoded. For the present embodiment, we encode the video using the H.264 or HEVC codecs which are used for optimal video transmission. It should be noted that there are no losses in image information due to projection transformations, since there are none. The only losses in image quality are those incurred during the encoding process. It is well understood that in some locations, where a higher upload bandwidth is available, encoding losses can be lowered, while in locations where upload bandwidth is poor, the encoding losses will be higher. The goal is to push the highest resolution video to the cloud as possible.

Thereafter, the video frames are sent to the network interface card (7), being converted to an Internet Protocol (IP) stream and packaged suitably for transport to the internet (10), typically being connected via a cat6 patch cable (9), fiber optic link, or wireless transmission. In the context of video streaming, latency is the amount of time between the instant a frame is captured and the instant that frame is displayed in the user's end device. Live linear broadcasts are typically delayed by a latency of approximately seven seconds. This is done so that objectionable content can be filtered out. This delay, however, is not required for streaming, and is in fact inimical to the wagering process. By employing low latency (1−0.2 sec typical) transports such as WebRTC at every communication node, we can realize aggregate latencies from “live” to the placing of a wager to between 3-5 seconds.

A cloud server intercepts the encoded IP stream (11), replicates the packets, transmitting each encoded IP video frame to as many users as request the image via their remote devices (12), whether mobile phone, tablet, “smart” internet-enabled television or PC, or VR headset. This act of replicating and propagating IP packets is the basis for what is termed in the industry a Content Distribution Network (CDN). As the details of this system, it will be clear that in order to facilitate the described system and method, it is necessary for the CDN to not only replicate and transmit video frames, but to cache them for later retrieval. Often, the CDN transcodes the data packets as well as buffering them. Popular transcoded formats are HLS and DASH, although unbuffered, sub-second latency protocols such as WebRTC are preferred for the reasons described above.

Users consuming the video stream may be physically present at the event, or physically remote, for example, viewing the live event on a mobile device, television, computer system, or the like. All users interact with the streamed IP video via a customized software application. This application can, on personal computers, run in a web browser environment, run as a standalone application with optimizations made for the respective platform, or the like. Support for VR headsets may be accomplished by off-axis projection or other algorithms as are well understood in the field of stereoscopic image processing. Thus, each user is free to uniquely pan, tilt, and zoom (PTZ) in the immersive environment.

Along with the camera/video capture system, the system requires an object tracking system OTS). In the present embodiment, a radio frequency (RF) system is employed. There are numerous third-party vendors that provide the infrastructure and technology to capture this information. The input to the object tracking system (OTS) is the plurality of transmitters located on players, the ball (or puck), coaches, and staff. The output from the OTS is typically a “UDP Blast”. UDP (User Datagram Protocol) is a transmission protocol used for low-latency, loss-tolerating connections between applications. Unlike TCP, it does not require a return acknowledgement that the data packet was received. The UDP is ingested into the workstation (5) via a standard 10-BaseT network interface card (7), which are commonly integral to the computer mainboard.

Software hosted by the computer reads the serial stream and synchronizes it with the ingested video frames from the camera system. The UDP blast is a time-stamped list of positions in Cartesian coordinates as well as identification value that corresponds to a unique object. The camera system(s) must be calibrated with the OTS. In other words, the origin (0, 0, 0) in OTS space must be aligned with some known boundary (e.g., we know a priori the court size), or some other fiducial from which measurements may be determined.

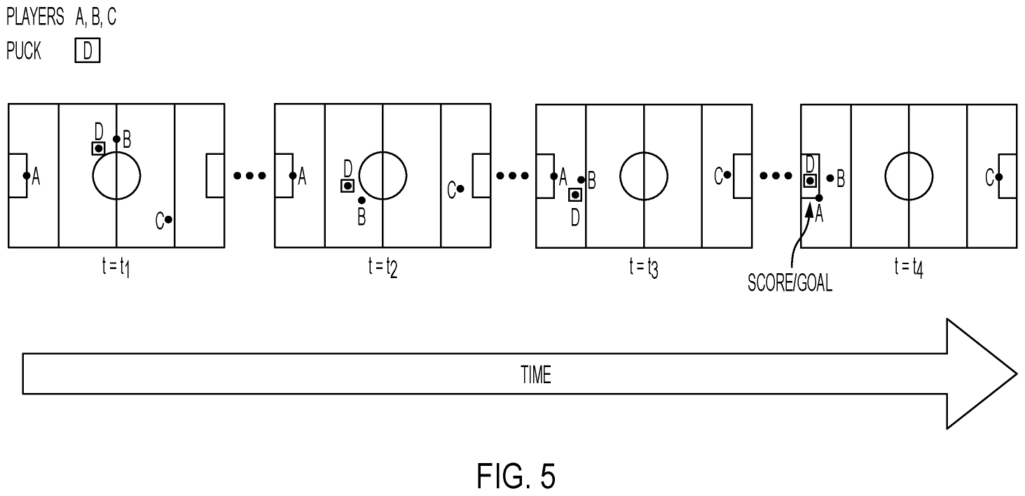

A simplified view of object tracking is important to our discussion, and is shown in FIG. 5. In the series of snapshots in time, three players are shown, A, B, and C, and a puck D. Time progresses from left to right. One can see during this progression that player B has the puck D and is advancing to A's goal. In the right-most snapshot we see that the puck is with A's goal—hence a scoring event has occurred. In reality, this play may take four seconds, and the OTS is supplying tracking information at 150 Hz, thus, during the course of the play shown, 600 tracking updates have been made. The OTS data, as ingested by the workstation (5) is serially packed with each video frame, such that each and every streamed frame has coordinates in the space captured by the video camera for each and every object.

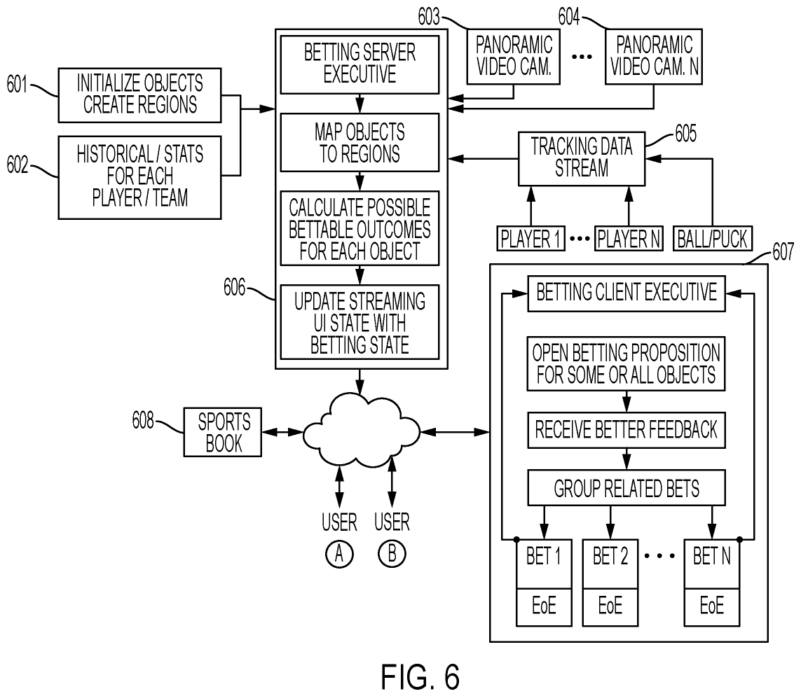

FIG. 6 provides a description of the software/method for performing the described system and method. Generally, the software is organized along a server-client model, where the betting or wagering server executive (606) is responsible for ingesting video and tracking data, then outputting an immersive stream as described in detail in the preceding paragraphs, where bettable outcomes for each object are stored as metadata. This information is then made available to the betting client executive, which also receives input from betting users, manages the wagers, signals End of Events (EoE's), then signals to a third-party sportsbook regarding the status of the wagers. We will describe each component in the sequence in which they occur.

The present embodiment of the software is configured as a temporal finite state machine (tFSM). The tFSM paradigm is well understood in the art of computer programming and engineering. A FSM is a mathematical model for any system with a limited number of conditional states of being. The model may be implemented through both hardware and software. Temporal add the dimensionality of time to the model. As the number of inputs to a system increases (e.g., players and objects), the number of states and the complexities of transitions grows exponentially, but is nevertheless finite.

The first step in our method, as shown in FIG. 6, is to initialize the objects (601). Objects, in our paradigm, are anything that is being tracked. Examples include the ball (or puck), players, coaches, referees, and the like. The process of initialization assigns alphanumeric identifiers (ID's) to each object, as well as historical metadata. For example, let's assume we have a hockey player John Doe. In the tracking engine (605), a unique physical transceiver exists for each object, including John Doe. That transceiver pair has a unique ID—let's say A100E53.

Furthermore, let's say the John has accumulated the following statistics during his career to-date:

GP: games played

G: Goals

A: Assists

S: Shots on goal

PN: Penalties assessed

ATOI: Average time on ice per game

Thus, an XML (extensible markup language) file with these stats would be:

<?xml version=“1.0” encoding=“utf-8”?>

<Metadata>

<PlayerName>John Doe</PlayerName>

<PlayerID>A100E53</PlayerID>

<GP>76</GP>

<G>88</G>

<A>93</A>

<PN>14</PN>

<ATOI>47:18</ATOI>

</Metadata>

In addition to these highly-simplified statistics, we can add statistics that are relevant to the betting scenarios to be employed during the game. For example, we may expand the average goals per game to include information such as when those goals were made (e.g., what period, or even more granular). As we will discuss, this historical information is then used for weighting the betting odds. These statistics are not intended to be limiting—merely examples. If John Doe were a goaltender, other statistical metrics would be included. Obviously, the metrics for another sport, such as basketball, will differ significantly. Moreover, team statistics may be added to the personal statistics. The intent here is twofold—to provide historical data for the purposes of computing probabilities, as well as to provide betting contexts. The means of storing this metadata is not critical; it may be in XML, JSON, CSV format. Although these files are used collectively to initialize the state machine for all objects (with the exception of the ball or puck), they are also updated during the course of the game or match so that the betting odds are as accurate as possible.

In addition to initializing objects by associating tracking IDs and metadata, we need to initialize and calibrate the playing field or court (602). We will use the term Field of Play (FOP) for our discussion. The FOP is logically divided into a grid of some dimensionality that makes sense for the sport in question. The zero-point, or Cartesian origin (X=0,Y=0,Z=0) must be co-aligned or calibrated to the origin in the virtual space as captured by the one-or-more panoramic cameras (603,604). This, in turn, must align with all object transceiver's origin point. For example, in basketball, where we have a rectangular court, the origin may be located in one of the corners. We may elect to put a fiducial transceiver precisely at the origin corner. In this way, all other transceivers reference their coordinates from this fiducial. Alternatively, each transceiver may be, prior to the game, physically “walked over” to the origin, and then “reset” such that that transceiver is now reporting (0, 0, 0) with some degree of precision, while at that location. A hockey court does not have a rectangular shape, and thus it may make sense to locate the origin at center ice. It should be understood, that in our example of Cartesian coordinates, X and Y refer to directions along the long axis and the short axis of the court, respectively, while Z refers to motion above the court. Thus, if a basketball player were to jump, their Z value would increase. The coordinate system should be understood to be completely arbitrary. We could elect to use spherical coordinates (r, θ, ϕ), rather than Euclidian three space. The dimensions of each grid section may be “tuned” to each sport and to the spatial resolution of the tracking transceivers. For example, a modem transceiver will have spatial resolution<1 m³, thus, making grids smaller than that dimension would be computationally pointless.

As shown in FIG. 6, we now proceed beyond the initialization state to the actual operation of the state machine. The betting server executive (606) performs multiple operations. The first block depicts how the model receives state information regarding all objects from the tracking engine (605). Thus, the FSM is event-driven, typically at a constant frequency, that frequency being determined by the tracking system. For example, in the present embodiment, the FSM is receiving object updates at 150 Hz. This temporal resolution must be matched to the sport. “Fast” games such has hockey and basketball require higher temporal resolution than, for example, soccer. In this block, the software maps the objects from the tracking transceiver domain, to the virtual domain as captured by a single video frame from each panoramic camera (603, 604). Thus, at the end of this block iteration, each object will be mapped to a virtual grid location.

The next operation in the block diagram is the calculation of all possible bettable outcomes. The types of bettable outcomes are determined, per sport, a priori. For example, in hockey we might wager on the following:
Player John Doe makes a score in the next three minutes (or by the end of the period).
Player John Doe (if goaltender) blocks all shots in the next five minutes.
Player John Doe spends time in the penalty box.
Player John Doe's team scores.

Obviously, the betting scenarios are substantially different, say, for basketball:
What is the likelihood that John Doe's next basket will be a three-pointer?
What is the likelihood that John Doe will score the final points or the winning shot?
What is the likelihood that John Doe scores twice in the next five minutes?
What is the likelihood that John Doe will outscore player X from the opposing team?

It is precisely these types of ephemeral micro-betting scenarios that this present system is attempting to capture. By being immersed in the game via panoramic video, with the social context of viewing the game with others, and by integrating with tracking technology and a powerful real-time betting engine, we can create a scenario for this type of natural betting.

Per our previous descriptions, the tracking engine (605) is supplying updated coordinates for each object at a specified frequency. Using current information along with previous information, we can now calculate betting odds as follows:

1. Calculate velocity and acceleration for each object. Motion analytics may be more complex given the sophistication of the tracking transducer. For example, players may wear multiple transducers, or transducers may have on-board MEMS accelerometers. With this additional information, it is possible to determine, for example, if an object is rotating. This additional information can be used to further enhance the predictive analytics.

2. Given the past trajectory, and current velocity and acceleration, we determine for each object its predicted trajectory. We do this computation for some pre-determined epoch of time, relative to each sport. For example, for a “fast” game such as hockey, it would be pointless to compute predictions for more than three seconds since the puck will likely have changed trajectory within that epoch, and the hence, too, the players in response. Various computational methods exist for this type of predictive analysis, including linear regression analysis, least squares estimates, and predictive means using artificial intelligence. Although there are some intricacies involved with this step, such as noise filtering, removing outliers, and the like, it should be appreciated that there are numerous well-understood solutions to predicting object trajectories.

3. Using the a priori metadata stored with each object, we can formulate weights that can be used in betting calculations. As the reader will recall, this information is used to initialize each object (e.g. player), and is continuously updated as the game proceeds. For example, our metadata may contain probabilities that John Doe scores 10% of the time when he is within one meter of the goal, and 15% of the time when he is between one and ten meters away from the goal. We may have other metadata that suggest that John Doe is more 20% more likely to score in the third period. Thus, if the tracking data places John Doe at 2.5 m from the net in the third period, we can use the weighted improvement in probability to offer the best odds. This description does not prescribe how to code such data structures as these are obvious to those skilled in the art, and these examples are not intended to be limiting in any way. In another embodiment of probability calculations, we make use of the Poisson distribution. This particular distribution is useful for calculating how many times an event is likely to occur in a specified interval. It is beneficial when one knows how often the event has occurred historically.

P(x;μ)=(e^{-μ}*μ^{x})/x!

where μ is the expected number of occurrences (the mean event rate), “e” is Euler's number, and “!” is the factorial symbol. As an example, let us assume that for player John Doe, we have historical data indicating that within the first 25 minutes of play, he makes, on average, three shots on goal. We want to wager on the probability that he will, in the current game, make four shots in the same period. We use the Poisson distribution to calculate this probability:

P(4;3)=(e⁻³*3⁴)/4!≅17%

Using the Poisson distribution is computationally inexpensive and hence is reasonable, but non-limiting means for calculating probabilities. In our FSM implementation, we are bound computationally by the resources of the system, and constrained by the tracking update frequency and the number of objects being tracked. In ice hockey, the roster is twenty players, with six on the ice, while in basketball, there are fourteen players and five on court. Current GPU processing realizes over 15 TFLOPS (15 trillion floating point operations a second), so while there are a massive amount of computations to perform with each tracking update, modern computing systems are capable of the work load in real time.

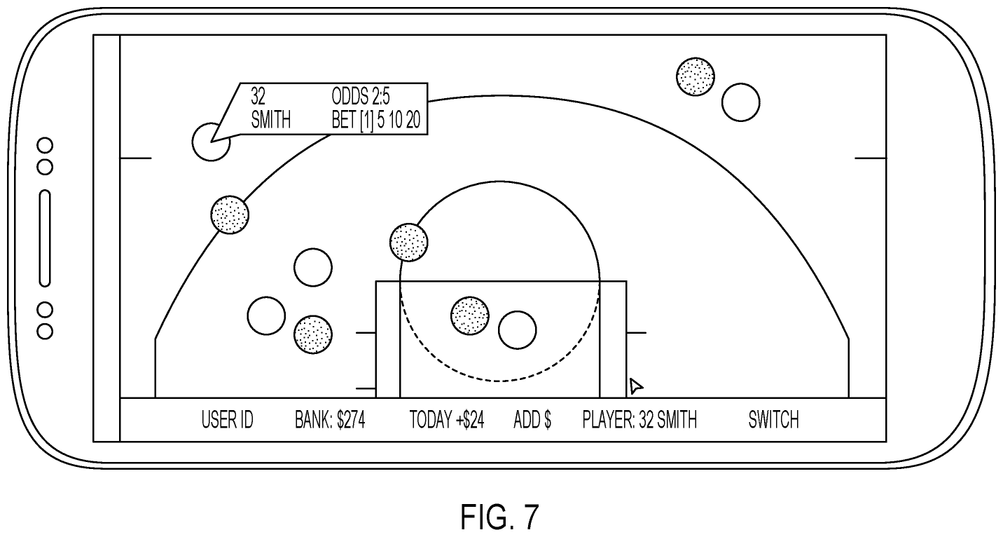

The next step in the progression is the updating of the user interface with betting state information. This is a panoramic view as is shown on a mobile phone in FIG. 7. This view, or scene, is streamed on a frame-by-frame basis to all end users. In previous disclosures, as referenced previously in this disclosure, we have disclosed the means to transferring real-time tracking data with each video frame. In the present disclosure, we extend the data to include betting scenarios and odds for some or all of the objects being tracked. In previous disclosures we discussed how the tracking information could be used to create an isolated and self-adjusting pan, tilt, zoom (PTZ) view within the immersive environment. The same information, in conjunction with the calculation of betting scenarios, is presented here.

Referring now to FIG. 7, where a user's mobile device is shown with a simplified view of a basketball game from a perspective above the rim on one of the hoops. Understand that each unique user is free to choose his/her own view from the one-or-more panoramic cameras employed in the game, since the entire panorama from one or more cameras is being streamed to the mobile device. In this example, players from two teams can be seen, in two colors, with betting metadata shown for player SMITH, #32. This “data” view that corresponds to the live (streamed) video view can be managed in multiple ways. In one embodiment, the user can toggle between the two views. This may be advantageous for smaller, less powerful phones, or in situations where the bandwidth is constrained. In a second embodiment, the view shown in FIG. 7 could be an inset or sub window, where the main window is showing the live, immersive game. In a third embodiment, three-dimensional graphics can be used to highlight and interact with betting on players. Although this type of video augmentation is commonly done for replays in linear broadcasting, what is novel is the ability to perform the operation on a streaming platform with micro-betting opportunities.

There are several ways with which the end user may interact and place bets. For example, simply selecting the player, whether on the live video or on the in-set (2D) representation, or, more simply via a menu where all of the current players for both teams are listed. This action would then highlight, graphically, the player and “follow” it in the immersive environment. Another way to choose the player, would be to use voice activation, which is now integral with all mobile platforms, for example, “Digital Assistant, I want to be on player SMITH, #32.”. Naturally, the user interface may also allow any player to be automatically tracked such that the user's PTZ will be dynamically adjusted to center the player in the screen. Once highlighted, the betting scenarios for that player can be viewed, and dollar amounts chosen, based upon a user's credit. Again, these scenarios are pre-determined for each sport, yet ephemeral in the sense that each user, as a bettor, can bet with one or more bettors on each of the outcomes, as they are immersed in the game.

For our example, one scenario is that SMITH, who has the ball, makes a three-pointer in his next shot. The user interface may contain the user's current betting status (win/loss), and other graphical aids, such as a heat map that shows where a player's odds of making a shot increase. For example, SMITH may make 80% of his shots when he is within the lane lines; this area could have a translucent red overlay. Once the user chooses the betting scenario and confirms, the bet is considered registered, and the information is relayed to the betting client executive process upon which the bets are aggregated (607) and processed.

Up to this point, every operation has been performed at the event facility on the workstation (5) hosting the camera(s) and ingesting the tracking data. The betting server executive (606) communicates information via the web to a betting client executive (607). This software may reside on one of the CDN servers, or on a purpose-tuned server or server cluster. Like each user viewing the event, the betting server receives information regarding all possible bettable outcomes for each object in real time. Due to the critical temporal nature of the system, low latency protocols such as WebRTC are employed in the communication between the server and client.

We now discuss the operations of the betting client executive (607). One task is the association (matching, grouping) of bets. For example, we may have 2000 individuals who are wagering on the SMITH—three-point shot scenario, while 500 are wagering on a second scenario involving SMITH, while yet another 10,000 are wagering on other players and scenarios. Each and all similar bets (e.g., same player and scenario) are accumulated, waiting for an End of Event (EoE). Each aggregated bet is spawned off as a new thread or process, awaiting the EoE trigger which will typically come asynchronously from all other EoEs. An EoE may be an event such as “SMITH scores”, or it may be a timeout situation such as “SMITH scores in the next three minutes”. It is possible that an EoE coincides with the end of the game—“SMITH scores 10 points by the end of the game”, or is a compounded event—“SMITH and WILLIAMS combined score 12 points in the next 8 minutes.” Thus, the betting client executive server process is in charge of managing the plurality of EoE's by monitoring both the clocks, if applicable, on a process, or on score-based outcome monitoring.

For each concurrent betting process reaching an EoE, at the conclusion, a tertiary process can be notified of the bets and bettor's outcomes, such that accounts can be adjusted based upon win or loss. In the present embodiment, this is handled by an online third party story book service (608) which is notified via the betting client executive. It is through this service that users may register, pass security measures, and otherwise qualify to become bettors. And likewise, it is through this service that all final financial transactions occur. This is not a necessary component of this system as users are free to bet “for fun” with no monetary stipulations. This type of transactional process is typically handled by an API (Application Programming Interface) provided by the story book host.

Other embodiments of this system may be integrated with fantasy sports. Embodiments may also include event sponsors offering coupons or gift cards in lieu of currency upon completion of successful wagering. Yet another embodiment allows the user to make bets on multiple players, and also in multiple concurrent games. The user may, via a menu interaction, cycle between multiple live events, wagering on multiple outcomes on multiple players. A home, or landing screen, can be used to tally the aggregate betting information, including number of active wagers, current wins and losses, the presence of online “friends”, and the like. In another embodiment, the user interface has the ability to “freeze” or suspend the live action, including the ability to replay buffered video.

In another embodiment, the betting client executive has the ability to notify bettors as to the outcome of their bets asynchronously. For example, if a user is switching between multiple games, placing wagers all the while, the betting server process may still report on outcomes that are not presently being viewed. In this way a user may make many wagers. In another embodiment, the user interface is updated with information regarding bets that others are making. This can then be an indication of where the largest betting opportunities can be found. Included in this concept is the ability to see or share one's friend's betting statistics in one's personal user experience, thus being challenged by their successes or losses.

It will be appreciated by those skilled in the art that embodiments provided herein are equally applicable to various sports and other events where multiple cameras and views are desirable.

While the various example embodiments have been described in connection with the examples provided herein, these were provided as non-limiting examples. Accordingly, embodiments may be used in similar contexts with similar devices and methods.

It will also be understood that the various embodiments may be implemented in one or more information handling devices configured appropriately to execute program instructions consistent with the functionality of the embodiments as described herein. In this regard, FIG. 2 illustrate a non-limiting example of such devices and components thereof.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is a non-transitory storage medium, inclusive of all storage media other than signal or propagating media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the functions/acts specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
transmitting, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes;
receiving tracking information corresponding to positions of objects within the live event;
providing, on a user interface of each of the plurality of users, betting information within the panoramic augmented video stream;
receiving, from at least one of the plurality of users, input corresponding to a bet by the at least one of the plurality of users in response to the betting information; and
registering the bet within a betting client.

2. The method of claim 1, comprising assigning identifiers and historical metadata to each of the objects, wherein the metadata is derived from at least a portion of the historical metadata.

3. The method of claim 1, wherein the providing betting information comprises calculating, utilizing the metadata, betting odds for each of a plurality of events yet to occur within the live event.

4. The method of claim 3, wherein the calculating occurs in real-time as the positions of the objects is updated.

5. The method of claim 1, wherein the providing comprises providing betting information corresponding to a viewing perspective of a user.

6. The method of claim 1, wherein the receiving comprises receiving, by the at least one of the plurality of users, a selection of an object within the viewing perspective of the at least one of the plurality of users.

7. The method of claim 1, wherein the registering comprises aggregating bets having a same end of event trigger.

8. The method of claim 1, comprising adjusting an account of the at least one of the plurality of users based upon an outcome of an event corresponding to the bet.

9. The method of claim 1, wherein the providing comprises providing betting information based upon an account value of the at least one of the plurality of users.

10. A system, comprising:
a processor;
a memory device comprising instructions executable by the processor to:
transmit, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes;
receive tracking information corresponding to positions of objects within the live event;
provide, on a user interface of each of the plurality of users, betting information within the panoramic augmented video stream;
receive, from at least one of the plurality of users, input corresponding to a bet by the at least one of the plurality of users in response to the betting information; and
register the bet within a betting client.

11. The system of claim 10, comprising assigning identifiers and historical metadata to each of the objects, wherein the metadata is derived from at least a portion of the historical metadata.

12. The system of claim 10, wherein the providing betting information comprises calculating, utilizing the metadata, betting odds for each of a plurality of events yet to occur within the live event.

13. The system of claim 12, wherein the calculating occurs in real-time as the positions of the objects is updated.

14. The system of claim 10, wherein the providing comprises providing betting information corresponding to a viewing perspective of a user.

15. The system of claim 10, wherein the receiving comprises receiving, by the at least one of the plurality of users, a selection of an object within the viewing perspective of the at least one of the plurality of users.

16. The system of claim 10, wherein the registering comprises aggregating bets having a same end of event trigger.

17. The system of claim 10, comprising adjusting an account of the at least one of the plurality of users based upon an outcome of an event corresponding to the bet.

18. The system of claim 10, wherein the providing comprises providing betting information based upon an account value of the at least one of the plurality of users.

19. A product, comprising:
a storage device that stores code, the code being executable by a processor and comprising:
code that transmits, to a plurality of users, a panoramic augmented video stream corresponding to a live event, wherein each of the plurality of users provide input to view a viewing perspective independent from viewing perspectives of other of the plurality of users, wherein the panoramic augmented video stream comprises metadata corresponding to bettable outcomes;
code that receives tracking information corresponding to positions of objects within the live event;
code that provides, on a user interface of each of the plurality of users, betting information within the panoramic augmented video stream;
code that receives, from at least one of the plurality of users, input corresponding to a bet by the at least one of the plurality of users in response to the betting information; and
code that registers the bet within a betting client.

20. The product of claim 19, comprising code that adjusts an account of the at least one of the plurality of users based upon an outcome of an event corresponding to the bet.
